(19) United States
(12) Patent Application Publication
(10) Pub. No.: US 2001/0008555 A1
(43) Pub. Date: Jul. 19, 2001

(54) System and method for inputting a web-page input data into a web page by employing a wire/wireless telephone

(76) Inventors: Mun Yeol Bae, Ulsan-shi (KR); Ja Suk Son, Pyongtaek-shi (KR)

Correspondence Address: STAAS & HALSEY LLP, 700 11TH STREET, NW, SUITE 500, WASHINGTON, DC, 20001, US

(21) Appl. No.: 09/757,525

(22) Filed: Jan. 11, 2001

(30) Foreign Application Priority Data
Jan. 15, 2000 (KR) 2000-1865
Jun. 21, 2000 (KR) 2000-34236

(51) Int. Cl. H04M 11/00

(52) U.S. Cl. 379/88.13

(57) ABSTRACT

A system for inputting a Web-page input data into the Web page, includes: a public switched telephone network (PSTN); a wire/wireless telephone, coupled to said PSTN, for sending a telephone call to said PSTN; and sending the Web-page input data in response to a set of guide messages; an interactive voice response (IVR) device, coupled to said PSTN, for sending the set of guide messages to said wire/wireless telephone in response to the telephone call; and converting the Web-page input data into a Web-page input code; and a Web server, coupled to said PSTN, for inputting the Web-page input code into the Web-page, thereby creating the Web page containing the Web-page input code as the Web-page input data. The system can save a time period taken to input the Web-page input data into the web page by employing the wire/wireless telephone. Further, the system can efficiently and simply input the Web-page input data into the Web page by employing the wire/wireless telephone.

### FIELD OF THE INVENTION

The present invention relates to a system and method for inputting a Web-page input data into a World-Wide Web (hereinafter, referred to as “Web”) page; and, more particularly, to a system and method for inputting the Web-page input data into the Web page by employing a wire/wireless telephone.

### DESCRIPTION OF THE PRIOR ART

Conventionally, in order to input a Web-page input data into a Web page contained in an Internet Web site, a user at a personal computer (PC) should access the Web page contained in the Internet Web site through a PC communication. However, if the user has not the PC or the user does not know how to use the PC, there is a problem that the user can not input the Web-page input data into the Web page contained in the Internet Web site. Accordingly, it is strongly needed that a system and method capable of inputting the Web-page input data into the Web page by employing a wire/wireless telephone.

### SUMMARY OF THE INVENTION

It is, therefore, an object of the present invention to provide a system and method capable of efficiently and simply inputting a Web-page input data into a Web page by employing a wire/wireless telephone.

It is, therefore, another object of the present invention to provide a system and method capable of saving a time period taken to input a Web-page input data into a Web page by employing a wire/wireless telephone.

In accordance with a first aspect of the present invention, there is provided a system for inputting a Web-page input data into the Web page, comprising: a public switched telephone network (PSTN); a wire/wireless telephone, coupled to said PSTN, for sending a telephone call to said PSTN; and sending the Web-page input data in response to a set of guide messages; an interactive voice response (IVR) device, coupled to said PSTN, for sending the set of guide messages to said wire/wireless telephone in response to the telephone call; and converting the Web-page input data into a Web-page input code; and a Web server, coupled to said PSTN, for inputting the Web-page input code into the Web-page, thereby creating the Web page containing the Web-page input code as the Web-page input data.

In accordance with a second aspect of the present invention, there is provided a system for inputting a Web-page input data into the Web page, comprising: a public switched telephone network (PSTN); a wire/wireless telephone, coupled to said PSTN, for sending a telephone call to said PSTN; and sending the Web-page input data in response to a set of guide messages; and a Web server, coupled to said PSTN, for inputting the Web-page input code into the Web-page, thereby creating the Web page containing a Web-page input code as the Web-page input data, said Web server including: an interactive voice response (IVR) device for sending the set of guide messages to said wire/wireless telephone in response to the telephone call; and converting the Web-page input data into the Web-page input code.

In accordance with a third aspect of the present invention, there is provided a method for inputting a Web-page input data into the Web page, comprising the steps of: a) sending a telephone call from a wire/wireless telephone to an interactive voice response (IVR) device; b) sending a set of guide messages from the IVR device to the wire/wireless telephone in response to the telephone call; c) sending the Web-page input data from the wire/wireless telephone to the IVR device in response to the set of guide messages; d) converting the Web-page input data into a Web-page input code in order to send the Web-page input code from the IVR device to a Web server; and e) inputting the Web-page input code into the Web-page, thereby creating the Web page containing the Web-page input code as the Web-page input data.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary block diagram illustrating a system for inputting a Web-page input data into a Web page by employing a wire/wireless telephone in accordance with an embodiment of the present invention;

FIG. 2 is an exemplary block diagram illustrating a system for inputting a Web-page input data into a Web page by employing a wire/wireless telephone in accordance with another embodiment of the present invention;

FIG. 3 is an exemplary flowchart illustrating a method for inputting a Web-page input data into a Web page by employing a system shown in FIG. 1; and

FIG. 4 is an exemplary flowchart illustrating a method for inputting a Web-page input data into a Web page by employing a system shown in FIG. 2.

### DETAILED DESCRIPTION OF THE INVENTION

Referring to FIG. 1, there is shown an exemplary block diagram illustrating a system for inputting a Web-page input data into a Web page by employing a wire/wireless telephone in accordance with an embodiment of the present invention. As shown, the system includes a wire/wireless telephone 10, a public switched telephone network (PSTN) 20, an interactive voice response (IVR) device 30 and a Web server 40. At first, the wire/wireless telephone 10, coupled to the PSTN 20, sends a telephone call to the IVR device 30 over the PSTN 20. Further, the wire/wireless telephone 10 receives a set of guide messages as a set of voice messages from the IVR device 30. The set of guide messages includes a guide message corresponding to a user identification data as a key or voice data and another guide message corresponding to the Web-page input data as another key or voice data, wherein the user identification data includes a user ID and a password.

In other words, in response to the guide message from the IVR device 30, a user at the wire/wireless telephone 10 inputs the user identification data into the wire/wireless telephone 10 by speaking the voice data into a microphone of the wire/wireless telephone 10 or pressing keys of the wire/wireless telephone 10. The wire/wireless telephone 10 sends the user identification data to the IVR device 30 over the PSTN 20. Further, in response to another guide message from the IVR device 30, the user at the wire/wireless telephone 10 inputs the Web-page input data into the wire/wireless telephone 10 by speaking another voice data into the microphone of the wire/wireless telephone 10 or pressing the keys of the wire/wireless telephone 10. The wire/wireless telephone 10 sends the Web-page input data to the IVR device 30 over the PSTN 20. The Web-page input data includes a user code number, and an equipment data, a freight data, a job progress data, a current location data and a reservation data by the day and time, which are corresponding to the user code number. The user code number includes a personal code number and a company code number.

The PSTN 20 switches the telephone call, the user identification data and the Web-page input data from the wire/wireless telephone 10 to the IVR device 30.

The IVR device 30, coupled to the PSTN 20, sends the set of guide messages to the wire/wireless telephone 10 over the PSTN 20. In other words, in response to the telephone call from the wire/wireless telephone 10, the IVR device 30 sends the guide message as the voice message to the wire/wireless telephone 10 so that the IVR device 30 can receive the user identification data as the key data from the user at the wire/wireless telephone 10. Then, in response to the user identification data from the wire/wireless telephone 10, the IVR device 30 verifies the user through the user identification data. Then, the IVR device 30 sends another guide message as another voice message to the wire/wireless telephone 10 so that the IVR device 30 can receive the Web-page input data as another key data from the user at the wire/wireless telephone 10. Then, the IVR device 30 converts the Web-page input data into a Web-page input code in response to the Web-page input data. Then, the IVR device 30 transmits the Web-page input code to the Web server 40. Then, the Web server 40 inputs the Web-page input code into the Web-page, thereby creating the Web page containing the Web-page input code as the Web-page input data.

The IVR device 30 includes a database (DB) 31 and a central processing unit (CPU) 32. The DB 31 stores the user identification data, the set of guide messages and the Web-page input data. The CPU 32, coupled to the DB 31, detects the set of guide messages based on a guide sequence from the DB 31 to transmit the set of guide messages to the wire/wireless telephone 10. Further, the CPU 32 converts the Web-page input data into the Web-page input code and transmits the Web-page input code to the Web server 40.

The Web server 40 includes a DB 41, a CPU 42 and a plurality of Web pages 43. The CPU 42 transfers the Web-page input code to the DB 41 in response to the Web-page input code so that the DB 41 can store the Web-page input code. Simultaneously, the CPU 42 inputs the Web-page input code into one of the Web pages 43, thereby creating the Web page 43 containing the Web-page input code as the Web-page input data. At this time, the Web page 43 containing the Web-page input code as the Web-page input data is loaded to an Internet Web site.

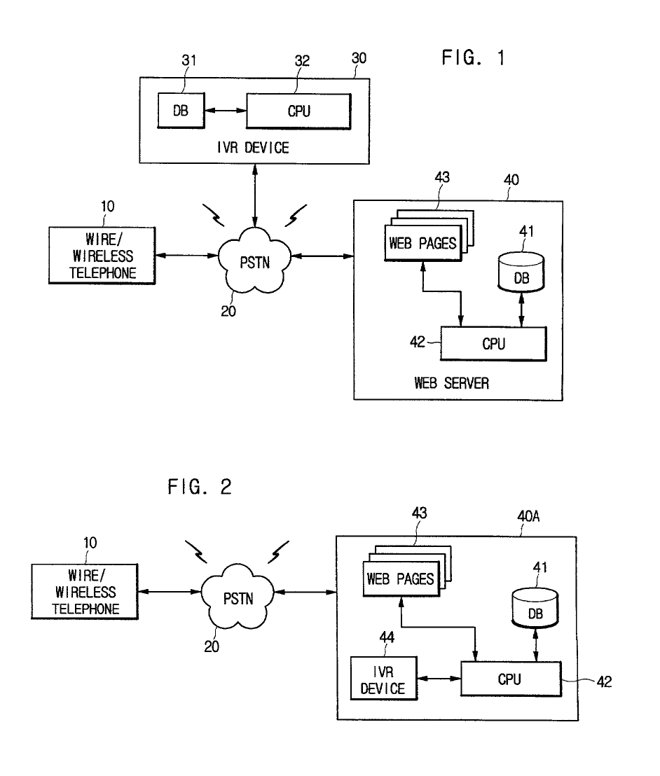

Referring to FIG. 2, there is shown an exemplary block diagram illustrating a system for inputting a Web-page input data into a Web page by employing a wire/wireless telephone in accordance with another embodiment of the present invention. As shown, the system includes a wire/wireless telephone 10, a PSTN 20 and a Web server 40A. The wire/wireless telephone 10 and the PSTN 20 shown in FIG. 2 substantially have the same functionality as those shown in FIG. 1. As compared to the Web server 40 separated from the IVR device 30 shown in FIG. 1, the Web server 40A shown in FIG. 2 includes an IVR device 44, wherein the IVR device can be implemented as an application-specific integrated circuit (ASIC). Similarly, the IVR device 44 shown in FIG. 2 substantially has the same functionality as the IVR device 30 shown in FIG. 1.

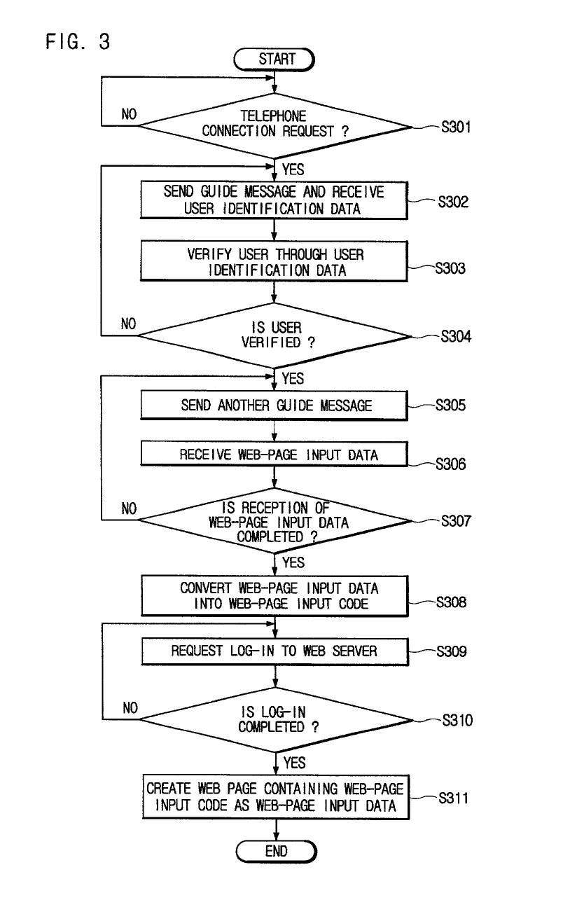

Referring to FIG. 3, there is shown an exemplary flowchart illustrating a method for inputting a Web-page input data into a Web page by employing a system shown in FIG. 1. The Web-page input data includes a user code number, and an equipment data, a freight data, a job progress data, a current location data and a reservation data by the day and time, which are corresponding to the user code number. The user code number includes a personal code number and a company code number. As shown, at step S301, the IVR device 30 determines whether it is received a telephone call as a telephone connection request from the wire/wireless telephone 10. If the IVR device 30 does not receive the telephone call from the wire/wireless, the step S301 is repeated. Otherwise, if the IVR device 30 receives the telephone call from the wire/wireless telephone 10, the IVR device 30 sends, at step S302, a guide message as a voice message to the wire/wireless telephone 10 in response to the telephone call.

Hereinafter, the IVR device 30 receives a user identification data as a key or voice data from a user at the wire/wireless telephone 10. Then, the IVR device 30 verifies, at step S303, the user through the user identification data. Then, at step S304, the IVR device 30 determines whether the user is verified. If the user is not verified, the steps S302 to S304 are repeated. Otherwise, if the user is verified, the IVR device 30 sends, at step S305, another guide message as another voice message to the wire/wireless telephone 10.

Hereinafter, the IVR device 30 receives, at step S306, the Web-page input data as another key or voice data from the user at the wire/wireless telephone 10. Then, at step S307, the IVR device 30 determines whether the reception of the Web-page input data is completed within a predetermined time period. If the reception of the Web-page input data is not completed within the predetermined time period, the steps S305 to S307 are repeated. Otherwise, if the reception of the Web-page input data is completed within the predetermined time period, the IVR device 30 converts, at step S308, the Web-page input data into a Web-page input code.

Hereinafter, the IVR device 30 requests, at step S309, a log-in to the Web server 40. Then, at step S310, the IVR device 30 determines whether the log-in is completed. If the log-in is not completed, the step S309 and S310 are repeated. Otherwise, the log-in is completed, the Web server 40 inputs, at step S311, the Web-page input code into the Web page, thereby creating the Web page containing the Web-page input code as the Web-page input data.

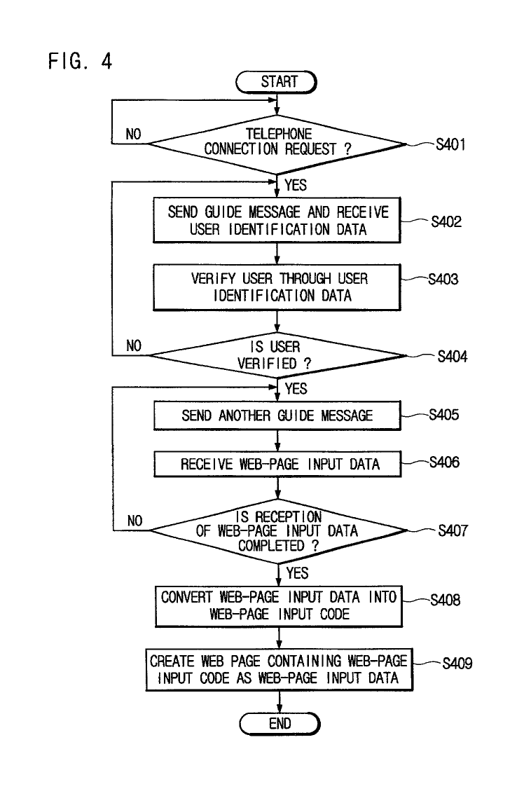

Referring to FIG. 4, there is shown an exemplary flowchart illustrating a method for inputting a Web-page input data into a Web page by employing a system shown in FIG. 2. The Web-page input data includes a user code number, and an equipment data, a freight data, a job progress data, a current location data and a reservation data by the day and time, which are corresponding to the user code number. The user code number includes a personal code number and a company code number. As shown, at step S401, the IVR device 44 contained in the Web server 40A determines whether it is received a telephone call as a telephone connection request from the wire/wireless telephone 10. If the IVR device 44 does not receive the telephone call from the wire/wireless, the step S401 is repeated. Otherwise, if the IVR device 44 receives the telephone call from the wire/wireless telephone 10, the IVR device 44 sends, at step S402, a guide message as a voice message to the wire/wireless telephone 10 in response to the telephone call.

Hereinafter, the IVR device 44 receives a user identification data as a key or voice data from a user at the wire/wireless telephone 10. Then, the IVR device 44 verifies, at step S403, the user through the user identification data. Then, at step S404, the IVR device 44 determines whether the user is verified. If the user is not verified, the steps S402 to S404 are repeated. Otherwise, if the user is verified, the IVR device 44 sends, at step S405, another guide message as another voice message to the wire/wireless telephone 10.

Hereinafter, the IVR device 44 receives, at step S406, the Web-page input data as another key or voice data from the user at the wire/wireless telephone 10. Then, at step S407, the IVR device 44 determines whether the reception of the Web-page input data is completed within a predetermined time period. If the reception of the Web-page input data is not completed within the predetermined time period, the steps S405 to S407 are repeated. Otherwise, if the reception of the Web-page input data is completed within the predetermined time period, the IVR device 44 converts, at step S408, the Web-page input data into a Web-page input code. Then, the Web server 40A inputs, at step S409, the Web-page input code into the Web page, thereby creating the Web page containing the Web-page input code as the Web-page input data.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A system for inputting a Web-page input data into the Web page, comprising:
a public switched telephone network (PSTN);
a wire/wireless telephone, coupled to said PSTN, for sending a telephone call to said PSTN; and sending the Web-page input data in response to a set of guide messages;
an interactive voice response (IVR) device, coupled to said PSTN, for sending the set of guide messages to said wire/wireless telephone in response to the telephone call; and converting the Web-page input data into a Web-page input code; and
a Web server, coupled to said PSTN, for inputting the Web-page input code into the Web-page, thereby creating the Web page containing the Web-page input code as the Web-page input data.

2. The system as recited in claim 1, wherein the Web-page input data includes a user code number, and an equipment data, a freight data, a job progress data, a current location data and a reservation data by the day and time, which are corresponding to the user code number.

3. The system as recited in claim 2, wherein the user code number includes a personal code number and a company code number.

4. The system as recited in claim 1, wherein the set of guide messages includes a first guide message corresponding to a user identification data and a second guide message corresponding to the Web-page input data.

5. The system as recited in claim 4, wherein said wire/wireless telephone, responsive to the first guide message, sends the user identification data as a key or voice data to said IVR device.

6. The system as recited in claim 4, wherein said wire/wireless telephone, responsive to the second guide message, sends the Web-page input data as a key or voice data to said IVR device.

7. The system as recited in claim 5, wherein said IVR device includes:
storage means for storing the set of guide messages as a set of voice messages, the user identification data and the Web-page input data; and
processing means, coupled to said storage means and responsive to the telephone call, for detecting the set of guide messages from said storage means; and sending the set of guide messages detected from said storage means to said wire/wireless telephone.

8. The system as recited in claim 7, wherein said processing means sends the first guide message to said wire/wireless telephone so as to receive the user identification data from said wire/wireless telephone; and verifies a user at said wire/wireless telephone in response to the user identification data from the user identification.

9. The system as recited in claim 7, wherein said processing means sends the second guide message to said wire/wireless telephone so as to receive the Web-page input data from said wire/wireless telephone; and converts the Web-page input data into the Web-page input code.

10. The system as recited in claim 1, wherein said Web server includes:
storage means for storing the Web-page input code; and
processing means, coupled to said storage means, for inputting the Web-page input code into the Web page, thereby creating the Web page containing the Web-page input code as the Web-page input data.

11. A system for inputting a Web-page input data into the Web page, comprising:
a public switched telephone network (PSTN);
a wire/wireless telephone, coupled to said PSTN, for sending a telephone call to said PSTN; and sending the Web-page input data in response to a set of guide messages; and
a Web server, coupled to said PSTN, for inputting the Web-page input code into the Web-page, thereby creating the Web page containing a Web-page input code as the Web-page input data, said Web server including:
an interactive voice response (IVR) device for sending the set of guide messages to said wire/wireless telephone in response to the telephone call; and converting the Web-page input data into the Web-page input code.

12. The system as recited in claim 11, wherein the Web-page input data includes a user code number, and an equipment data, a freight data, a job progress data, a current location data and a reservation data by the day and time, which are corresponding to the user code number.

13. The system as recited in claim 12, wherein the user code number includes a personal code number and a company code number.

14. The system as recited in claim 11, wherein the set of guide messages includes a first guide message corresponding to a user identification data and a second guide message corresponding to the Web-page input data.

15. The system as recited in claim 14, wherein said wire/wireless telephone, responsive to the first guide message, sends the user identification data as a key or voice data to said IVR device.

16. The system as recited in claim 14, wherein said wire/wireless telephone, responsive to the second guide message, sends the Web-page input data as a key or voice data to said IVR device.

17. The system as recited in claim 15, wherein said IVR device includes:
storage means for storing the set of guide messages as a set of voice messages, the user identification data and the Web-page input data; and
processing means, coupled to said storage means and responsive to the telephone call, for detecting the set of guide messages from said storage means; and sending the set of guide messages detected from said storage means to said wire/wireless telephone.

18. The system as recited in claim 17, wherein said processing means sends the first guide message to said wire/wireless telephone so as to receive the user identification data from said wire/wireless telephone; and verifies a user at said wire/wireless telephone in response to the user identification data from the user identification.

19. The system as recited in claim 17, wherein said processing means sends the second guide message to said wire/wireless telephone so as to receive the Web-page input data from said wire/wireless telephone; and converts the Web-page input data into the Web-page input code.

20. The system as recited in claim 11, wherein said Web server includes:
storage means for storing the Web-page input code; and
processing means, coupled to said storage means and said IVR device, for inputting the Web-page input code into the Web page, thereby creating the Web page containing the Web-page input code as the Web-page input data.

21. The system as recited in claim 11, wherein said IVR device is implemented as an application-specific integrated circuit (ASIC).

22. A method for inputting a Web-page input data into the Web page, comprising the steps of:
a) sending a telephone call from a wire/wireless telephone to an interactive voice response (IVR) device;
b) sending a set of guide messages from the IVR device to the wire/wireless telephone in response to the telephone call;
c) sending the Web-page input data from the wire/wireless telephone to the IVR device in response to the set of guide messages;
d) converting the Web-page input data into a Web-page input code in order to send the Web-page input code from the IVR device to a Web server; and
e) inputting the Web-page input code into the Web-page, thereby creating the Web page containing the Web-page input code as the Web-page input data.

23. The method as recited in claim 22, wherein the Web-page input data includes a user code number, and an equipment data, a freight data, a job progress data, a current location data and a reservation data by the day and time, which are corresponding to the user code number.

24. The method as recited in claim 23, wherein the user code number includes a personal code number and a company code number.

25. The method as recited in claim 22, wherein the set of guide messages includes a first guide message corresponding to a user identification data and a second guide message corresponding to the Web-page input data.

26. The method as recited in claim 25, wherein said step c) includes the steps of:
c1) sending the user identification data as a key or voice data from the wire/wireless to the IVR device in response to the first guide message; and
c2) sending the Web-page input data as another key or voice data from the wire/wireless to the IVR device in response to the second guide message.

27. The method as recited in claim 25, wherein said step b) includes the steps of:
b1) detecting the set of guide messages from a database; and
b2) sending the set of guide messages detected to the wire/wireless telephone.

28. The method as recited in claim 27, wherein said step b2) includes the steps of:
b2-a) sending the first guide message to the wire/wireless telephone so as to receive the user identification data from the wire/wireless telephone;
b2-b) verifying a user at the wire/wireless telephone in response to the user identification data; and
b2-c) sending the second guide message to the wire/wireless telephone so as to receive the Web-page input data from the wire/wireless telephone.
